(19) United States
(12) Patent Application Publication
(10) Pub. No.: US 2009/0169746 A1
(43) Pub. Date: Jul. 2, 2009

(54) METHOD OF TREATING A ONE-SIDE WELL-VENTILATED FABRIC FOR WATER REPELLENCE AND HYGROSCOPICITY

(76) Inventor: His-Tan CHEN, Tianjhong Township (TW)

Correspondence Address: SINORICA, LLC, 2275 Research Blvd., Suite 500, ROCKVILLE, MD, 20850, US

(21) Appl. No.: 11/967,367

(22) Filed: Dec. 31, 2007

(51) Int. Cl. B05D 5/00

(52) U.S. Cl. 427/256

(57) ABSTRACT

A method of treating a one-side well-ventilated fabric for water repellence and hygroscopicity is provided, water, a water repellence agent, a bridging agent, and an adhesive into an even compound extender being stirred and mixed into an even compound extender, the compound extender being poured by a material discharge device onto a surface of the fabric, and the compound extender that is controlled by a material removal device being evenly coated onto a surface of the fabric in a thickness. The compound extender is definitely adhesive and low in fluidity to control a portion of the fiber yarn of the surface of fabric the extender that permeates; one surface is formed with a water repellence layer and the other surface is formed with a hygroscopic layer for ventilation.

### BACKGROUND OF THE INVENTION

1. Field of the Invention

This invention relates to a method of treating a well-ventilated fabric and particularly to a method of treating a well-ventilated fabric for water repellence and hygroscopicity.

2. Description of Related Art

When being processed for the functions of water repellence and hygroscopicity, a conventional fabric is immersed in a hygroscopic agent to be dyed and thus after a fiber yarn of the fabric is made to absorb the hygroscopic agent, the fabric is dried to fall into a pattern with a hygroscopic power. Next, after one surface of the fabric is coated with a layer of resin for the formed pattern, a blocked layer is formed on the surface of fabric, and after the hygroscopic agent is coated on the blocked layer of the surface, a water-repellence layer is formed and the opposite side is a hygroscopic layer. However, the water repellence agent uses large quantity of water as a major raw material featured with good fluidity and permeability, so when the water repellence agent is coated, the surface of fabric must be coated with the layer of resin as the blocked layer, assuring that the water repellence agent cannot permeate the fiber yarn of fabric and the function of hygroscopic layer cannot be affected. Thus, the blocked layer blocks the water repellence agent from the fiber yarn on the surface of fabric, and due to easy removal caused by poor bonding strength, the firmness is poor after rinsing with water; moreover, the resin in the blocked layer fills small openings among the fiber yarns in the tissue of fabric, causing the treated clothes to be not permeable, although the fabric is of water repellence and hygroscopicity.

Consequently, because of the technical defects of described above, the applicant keeps on carving unflaggingly through wholehearted experience and research to develop the present invention, which can effectively improve the defects described above.

### SUMMARY OF THE INVENTION

In this invention, a method of treating a one-side well-ventilated fabric for water repellence and hygroscopicity, stirring and mixing water, a water repellence agent, a bridging agent, and an adhesive into an even compound extender. The compound extender is definitely adhesive and low in fluidity. When the fabric is delivered to a lower site of a material output device, the compound extender is poured on a surface of the fabric and a material removal device is used to evenly coat the compound extender on the surface of fabric in a predetermined thickness; a drying device is used to evaporate the moisture of compound extender and thus the water repellence agent permeates and bonds only a portion of the fiber yarn on the surface of fabric in a thickness and a surface is further formed with a water-repellence layer. A well-ventilated fabric provided with a hygroscopic layer is formed on the other surface, and with the low fluidity of compound extender, the thickness of processed fiber yarn permeating and bonding the surface of fabric may be effectively controlled.

### BRIEF DESCRIPTION OF THE DRAWINGS

FIG. 1 is a processing flow chart of a fabric according to this invention;

FIG. 2 is an enlarged plan view of the tissue of a knit fabric according to this invention;

FIG. 3 is an enlarged plan view of a material discharge and removal device according to this invention;

FIG. 4 is an enlarged 3D view of the tissue of a layout portion dried for a pattern according to this invention;

FIG. 5 is an enlarged sectional view illustrating the fabric dried for the pattern according to this invention;

FIG. 6 is a state view of water repellence and sweat ejection from the fabric according to this invention that is applied to the clothes; and

FIG. 7 is a state view of moisture absorption into and sweat ejection from the fabric according to this invention that is applied to the clothes.

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

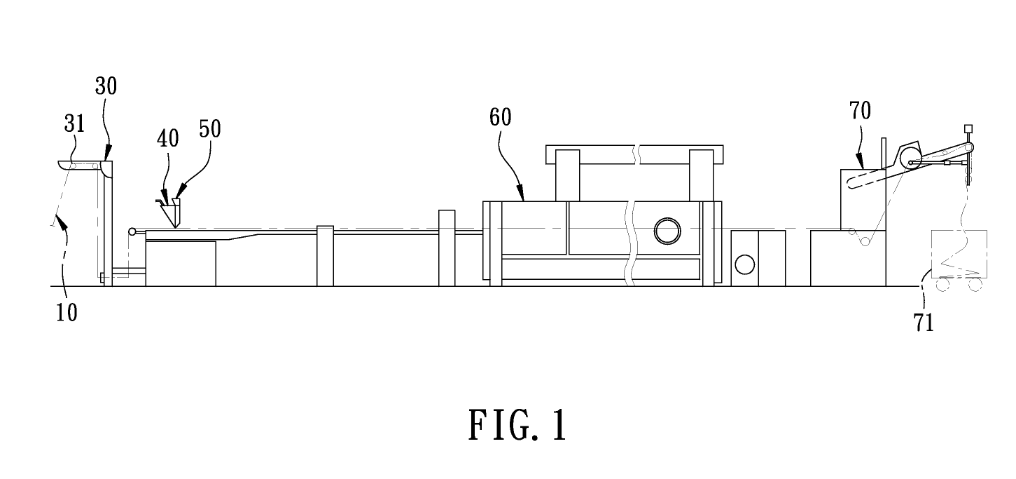

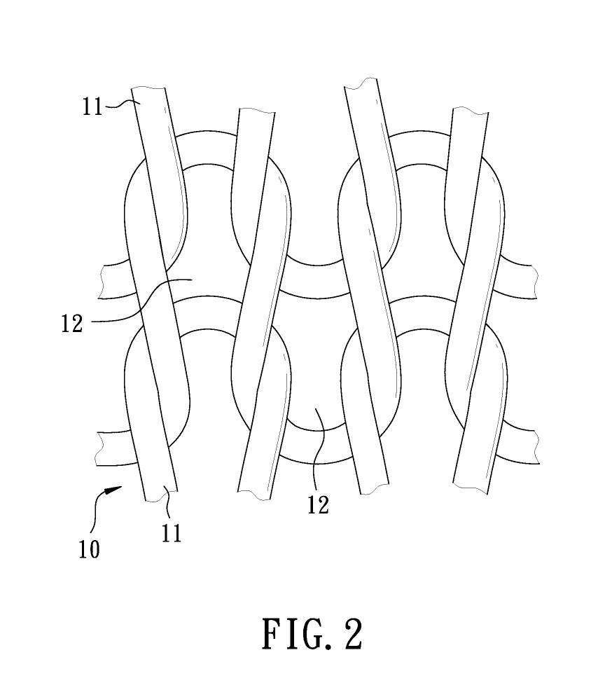

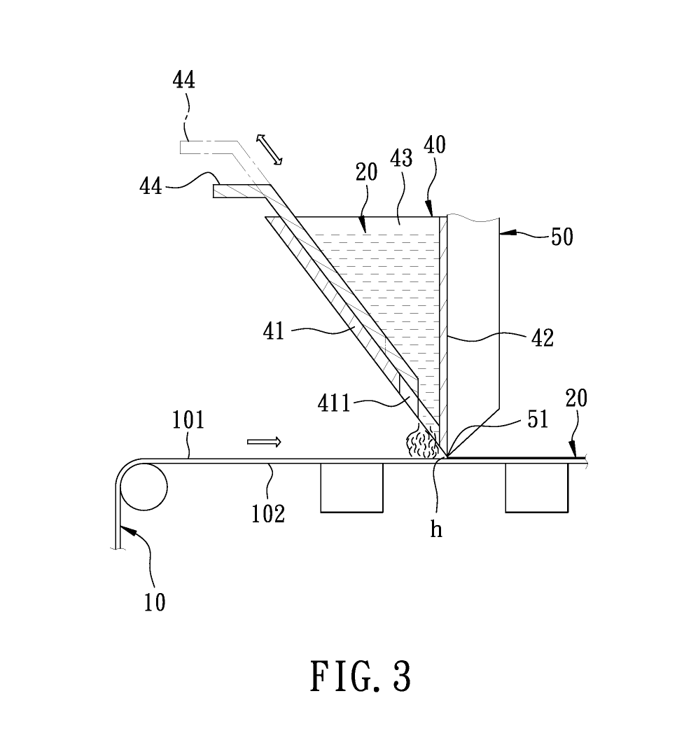

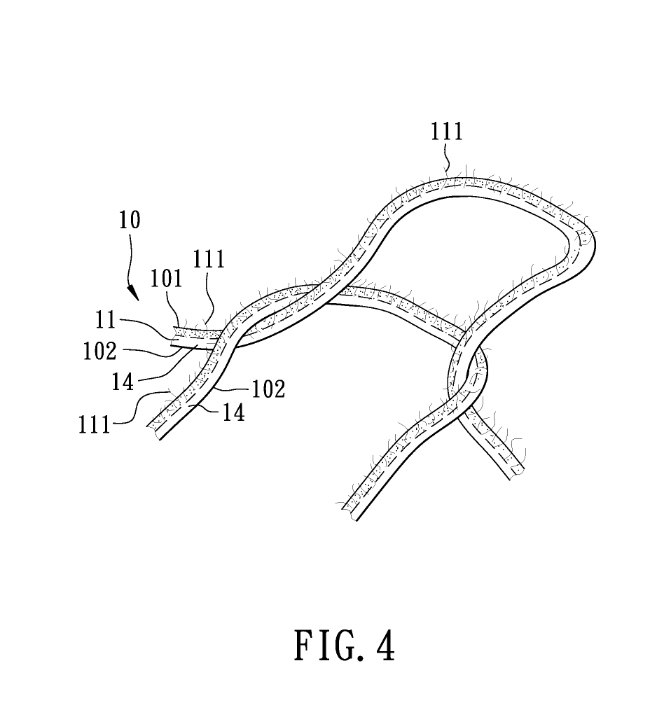

Refer to FIG. 1 illustrating a method of treating a one-side well-ventilated fabric for water repellence and hygroscopicity in a preferred embodiment of this invention, and the figure is a processing flow chart of this invention, comprising the following steps.
1. Choosing a fabric 10: with reference to FIG. 2 as an enlarged structural view of a general well-ventilated knit fabric, the fabric 10 is knit with a plurality of fiber yarns 11 in a thickness of 0.4 mm, the knit fiber yarns 11 are knit in a density of 22×22-38×38/square inch, and a small opening 12 is formed among the fiber yarns 11 for the air permeability of fabric 12; further, the fabric 10 may be in advance immersed in a hygroscopic agent for hygroscopicity processing, making the fabric 10 more higher in hygroscopicity; the fabric 10 may be a fatting fabric, a woven fabric, a mesh fabric, or a bird's-eye fabric for processing.
2. Preparing a compound extender: an adhesive of 1%-6% weight, a water repellence agent of 1%-14% weight, a bridging agent of 0.5%-1% weight, and rest of water are mixed into a raw material in a 100% weight ratio; after being mixed and stirred for around 2-4 minutes at an indoor temperature, the raw materials are evenly mixed into a compound extender 20 that higher in viscosity and lower in fluidity; the viscosity of compound extender 20 lies between 6000 and 25000 cps; in the embodiment, a W/O Inverse Acryl Hight Copolymer Emulsion is used for the adhesive, a high-performance fluorine compound contained in 3M Scotchgard™ protective agent PM-3630 is used for the water repellence agent, and a compound emulsified dispersant of Blocked Isocyanate is used for the bridging agent; when the fabric 10 is lower in density of knitting and the gap 12 formed during rewind and knit of each of the fiber yarns 11 is wider, the air permeability is higher; thus, the weight ratio of adhesive to the compound extender must be higher to increase the viscosity and decrease the fluidity and permeability; when the fabric 10 is thin, the viscosity of compound extender 20 must be increased as well.
3. Fabric feeding and material discharge: with reference to FIGS. 1 and 3 as enlarged views illustrating a processing flow and a material discharge and removal device according to this invention, through a plurality of rollers 31 of a conveying device 30, the fabric 10 is fed after another and passes through the lower site of a material discharge device 40; the material discharge device 40 is a lengthwise tank in an inverse triangle, of which of side is formed with a slanting soleplate 41 and the other side is formed with a straight plate 42, and an accommodation space 43 is formed between the sides for the compound extender 20; a plurality of material discharge holes 411 are provided in parallel passing through a bottom near the soleplate 41 and may be covered or opened, when a movable cover plate 44 moves, so as to control and adjust the quantity of material discharged out of the compound extender 20; next, when the fabric 10 passes through the material discharge hole 411, a top surface 101 of the fabric lies at a lower site of the material discharge hole 411, the compound extender 20, due to gravity, naturally passes downwards through the material discharge hole 411 and is thus poured on the top surface 101.
4. Coating for a thickness: with reference to FIG. 3 as an enlarged view illustrating a material discharge and removal device according to this invention, a material removal device 50 is provided near the rear of material discharge device 40; a knifepoint 51 is formed at a bottom of the material removal device 50, and a gap h of 0-50 μm is formed between an end of the knifepoint 51 and the top surface 101 of fabric 10 and is set in a thickness of the fabric 10; the thicker the fabric 10 is, the wider the gap h is, and the thinner the fabric 10 is, the more narrow the gap h is; when the fabric 10 passes through the material removal device 50, the knifepoint 51 removes redundant compound extender 20 and reserves a coat of adequate thickness on the top surface 101 of fabric 10, in which when the thickness of fabric 10 is very low, the knifepoint 51 may slightly touch the top surface 101 of fabric 10 to prevent too much compound extender 20 from permeating the fiber yarn 11, thereby controlling an extremely thin layer of compound extender 20 being coated on the top surface 101.
5. Drying for a pattern: the fabric 10 is fed into a drying device 60; a drying temperature is set between 110° C. and 190° C. and a drying time is set between 30 second and 10 minutes, in which the drying temperature and time is adjusted according to a thickness of the fabric 10 and that of the fiber yarn 11 into which the compound extender 20 permeates; for example, if the fabric 10 is thinner, the thickness of permeation of the compound extender 20 is lower and the drying time is shorter; thus, at the step, the moisture contained in the compound extender 20 is evaporated; with reference to FIG. 4 as an enlarged 3D view illustrating the tissue of a layout portion dried for a pattern according to this invention, the thickness of permeation of the water repellence agent into the fiber yarn 11 of the surface 101 of fabric 10 is around 0.1 through 0.3 mm; after the water repellence agent is fixed, much floss 111 is in parallel formed upwards on the surface of fiber yarn 11; with the floss 111 arranged, a water repellence layer 13 is formed on the top surface 101 of fabric 10; further, a portion of the fiber yarn 11 of a bottom surface 102 of the fabric 10, of which a thickness of 0.3-0.1 mm is reserved, is not bonded with the water repellence agent and thus formed into the hygroscopic layer 14; meanwhile, the water repellence agent, when being dried, is only bonded into the fiber yarn 11; thus, the gap 12 is not filled and the gap 12 of fabric 10 that is formed for ventilation is still reserved and well ventilated; later, the fabric 10 is delivered to the drying device 60 and gathered in a material barrel 71 by a gathering device 70; next, the fabric may also be rewound to form a column; thus, a finished product of fabric 10, of which the top surface 101 is formed with the water repellence layer 13 and the bottom surface 102 is formed with the hygroscopic layer 14 and well ventilated, is given.

In order to further make apparent the structural features, applied skill and manners, and expected effects according to this invention, what are applied in this invention are in detail described, and it is thus believed that this invention is thoroughly and concretely apparent, as described below.

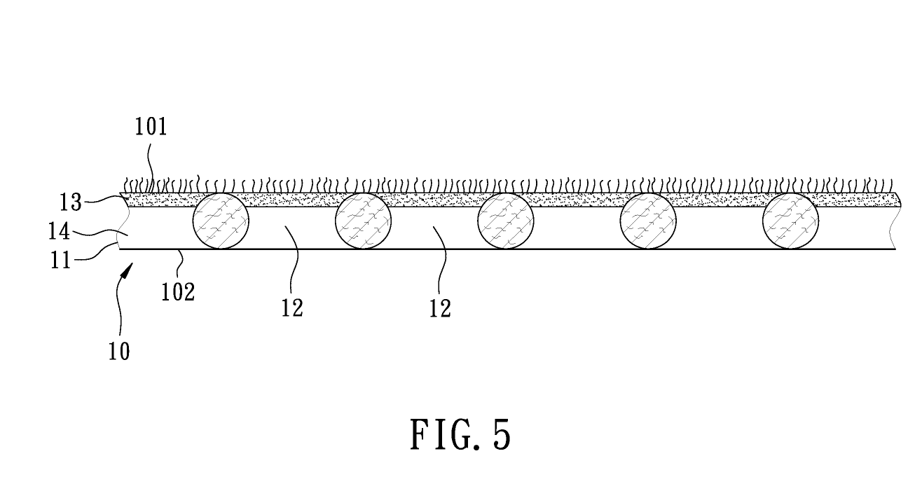

Refer to FIG. 5 as an enlarged sectional view illustrating the fabric that is processed. In this invention, the adhesive is used to enhance the viscosity of compound extender 20, thereby lowering its fluidity. Thus, the time and speed of permeation of the water repellence agent into the fiber yarn 11 of the top surface 101 of fabric 10 may effectively controlled so that after being processed, the fabric 10 of each specification, of which the top surface 101 is formed with the water repellence layer 13 and the bottom surface 102 is formed with the hygroscopic layer 14 and well ventilated, may be given.

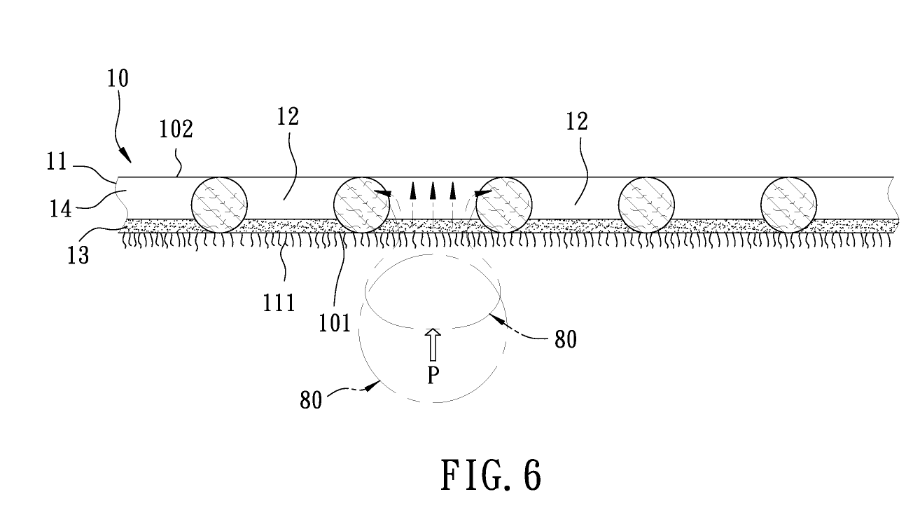

Refer to FIG. 6 as a state view of water repellence and sweat ejection from the fabric according to this invention that is squeezed with a force. When the fabric 10 is applied to the clothes, the water repellence layer 13 arranged at an inner side of the clothes touch a human's body and the hygroscopic layer 14 arranged at an outer surface of the clothes touch the outside environment. When a human being takes exercise to be wet with sweat 80, the floss 111 on the water repellence layer 13 does not absorb the sweat 80 and the sweat 80 squeezed with a pressure P by the human body during exercise flows towards the gap 12 between the water repellence layers 13. When moving through the gap 12 to touch the hygroscopic layer 14, the sweat is fast absorbed by the fiber yarn 11 between the hygroscopic layer 14 and then discharged out of the surface of clothes, thereby an effect of sweat exhaust being achieved. As described above, the fabric is especially applicable to the clothes that a user easily sweating in summer puts on, and the fabric applied in summer is thinner, so the processed fabric 10 according to this invention is applied. In addition to the effects of water repellence and hygroscopicity that are applied for fast sweat exhaust, the gap 12 may be matched for achievement of the well ventilated function, providing a set of clothes making the wearer comfortable and feel good.

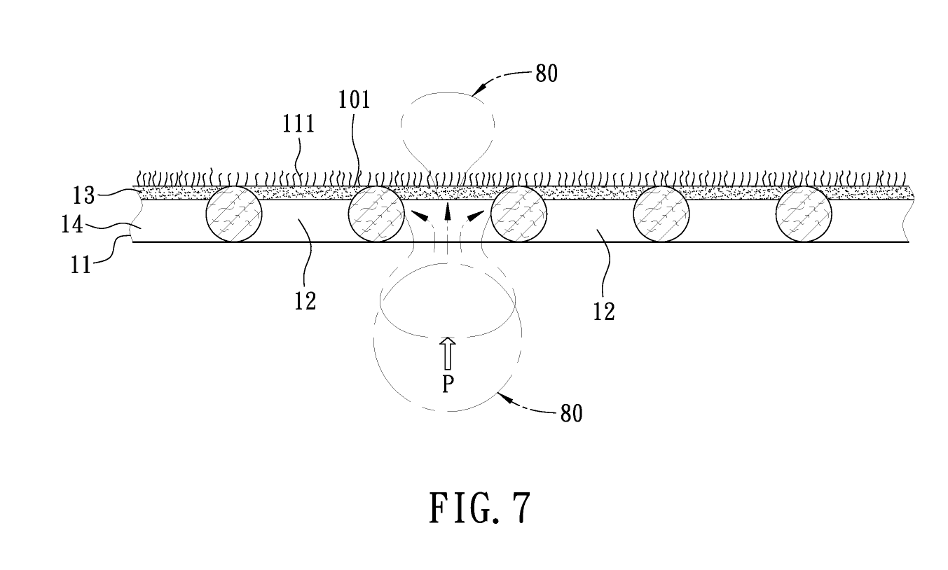

Refer to FIG. 7 as a state view of hygroscopicity and sweat exhaust from the fabric according to this invention. The fabric used in winter is generally thicker, and when the moisture is heavier, the water repellence layer 13 of the fabric 10 may be arranged on the outer surface of clothes to contact with the outside world. The hygroscopic layer 14 lies on the inner side of the clothes, so when there is water or oil outside touching the surface of clothes, due to no pressure applied, it is reflected and removed by the floss 111 on the water repellence layer 13 and thus does not stain on the clothes. Also, the hygroscopic layer 14 touches the human's body, so when the user is wet with sweat, the sweat 80 is fast absorbed and permeated into the fiber yarn 11 of the hygroscopic layer 14. At this time, when the exercise is taken on the body, the hygroscopic layer 14 is corresponding squeezed with the pressure P and the sweat also gets out of the water repellence layer 13 through the gap 12 on the fabric 10. Thus, the outside airflow or sunshine is used to fast evaporate the moisture and ventilate the fabric, making the wearer putting the clothes comfortable.

In another embodiment of this invention, a blowing agent may be added to and evenly mixed with the compound extender 20, thereby the compound extender of 1-5 times of foaming rate being achieved. The higher the magnification of foaming is, the less the ratio of adhesive comparatively is in a range of 1-3%; the content that is reduced is replaced in a ratio by the blowing agent. After the compound extender 20 is foamed, its density and unit weight decrease; thus, the compound extender 20 of the low fluidity and decreased unit weight may effectively control the thickness of fiber yarn 11 of the surface 101 of fabric 10, and for the thinner or thicker fabric 10 or the wider gap 12, the thickness of processed water repellence layer 13 may be controlled precisely.

Finally, it is nevertheless especially noted that the compound extender that is low in fluidity may effectively be controlled for the thickness of the surface of processed fabric into which the extender permeates, thereby the one-side well-ventilated fabric for water repellence and hygroscopicity being formed. The water repellence agent that permeates and is bonded into the fiber yarn is better in bondage strength and not easily removed, so the firmness of fabric after rinsed with water may increase; thus, the processed fabric may be widely applied to the clothes, sportswear and the like in different seasons, thereby the advantages of ventilation and comfort being achieved.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method of treating a one-side well-ventilated fabric for water repellence and hygroscopicity, comprising steps of:
1. choosing a fabric being knit with a predetermined fiber yarn and being well ventilated and hygroscopic;
2. stirring predetermined proportional water, water repellence agent, bridging agent, and adhesive at an indoor temperature and evenly mixing them into a compound extender of predetermined viscosity;
3. delivering the fabric to a lower site of the material discharge device provided with an accommodation space for the compound extender, in which a plurality of material discharge holes are formed at a bottom of the accommodation space for the compound extender to pass through and to be poured onto a surface of the fabric;
4. arranging a material removal device at the rear of material discharge device, in which when the fabric passes, a redundant portion of the compound extender may be removed by the material removal device and the extender of a predetermined thickness may be reserved and coated on the surface of fabric;
5. delivering the fabric to a drying device, in which the moisture contained in the compound extender is evaporated and removed so that the water repellence agent permeates and is bonded with a portion of the fiber yarn of the surface of fabric; thus, one surface formed with a water repellence layer being given and the other surface formed with a hygroscopic layer being given.

2. The method of treating the one-side well-ventilated fabric for water repellence and hygroscopicity according to claim 1, wherein the proportional compound extender comprises an adhesive of 1%-6% weight, a water repellence agent of 1%-14% weight, a bridging agent of 0.5%-1% weight, and rest of water are mixed into a raw material in a 100% weight ratio; the lower the knit density of fabric is, the higher the mixing proportion of adhesive is so that the viscosity of compound extender increases and lies between 6000 and 25000 cps and the mixing time lasts for around 2 through 4 minutes, in which a W/O Inverse Acryl Hight Copolymer Emulsion is used for the adhesive, a high-performance fluorine compound contained in 3M Scotchgard™ protective agent PM-3630 is used for the water repellence agent, and a compound emulsified dispersant of Blocked Isocyanate is used for the bridging agent.

3. The method of treating the one-side well-ventilated fabric for water repellence and hygroscopicity according to claim 1, wherein a blowing agent is added to and evenly mixed with the compound extender, the compound extender of 1-5 times of foaming rate is thereby achieved, and the higher the magnification of foaming is, the less the ratio of adhesive comparatively is in a range of 1-3%; the content that is reduced in a ratio is replaced by the blowing agent.

4. The method of treating the one-side well-ventilated fabric for water repellence and hygroscopicity according to claim 1, wherein a knifepoint is formed at a bottom of the material removal device, and a gap of 0-50 μm is formed between the knifepoint and the fabric surface to control the compound extender being coated on the surface of fabric in a thickness.

5. The method of treating the one-side well-ventilated fabric for water repellence and hygroscopicity according to claim 1, wherein a fabric drying temperature is set between 110° C. and 190° C. and a drying time is set between 30 seconds and 10 minutes.

6. The method of treating the one-side well-ventilated fabric for water repellence and hygroscopicity according to claim 1, wherein the fabric is well ventilated and hygroscopic.

7. The method of treating the one-side well-ventilated fabric for water repellence and hygroscopicity according to claim 1, wherein the thickness of fabric is between 0.3 mm and 2.0 mm and the fabric is knit in a density of 22×22-38×38/square inch.

8. The method of treating the one-side well-ventilated fabric for water repellence and hygroscopicity according to claim 1, wherein the thickness of fabric is 0.4 mm, the thickness of water repellence layer permeating and being bonded with the fiber yarn of the surface of fabric is between around 0.1 and 0.3 mm, and the thickness of hygroscopic layer is between around 0.3 and 0.1 mm.

9. The method of treating the one-side well-ventilated fabric for water repellence and hygroscopicity according to claim 1, wherein before the fabric is processed for water repellence, it is processed for hygroscopicity, in which the fabric is immersed in a hygroscopic agent and dried for a pattern for achievement of high hygroscopicity in the fabric.

10. The method of treating the one-side well-ventilated fabric for water repellence and hygroscopicity according to claim 1, wherein the fabric is a fatting fabric, a woven fabric, a mesh fabric, or a bird's-eye fabric for processing.
